(19) United States
(12) Patent Application Publication
(10) Pub. No.: US 2025/0192190 A1
(43) Pub. Date: Jun. 12, 2025

(54) METHOD OF MANUFACTURING A BIPOLAR PLATE FOR AN ELECTROCHEMICAL SYSTEM AND BIPOLAR PLATE FOR AN ELECTROCHEMICAL SYSTEM

(71) Applicant: Reinz-Dichtungs-GmbH, Neu-Ulm (DE)

(72) Inventors: Lisa JERG, Krumbach (DE); Bernd GAUGLER, Laichingen (DE); Stephan WENZEL, Tomerdingen (DE)

(21) Appl. No.: 18/970,612

(22) Filed: Dec. 5, 2024

(30) Foreign Application Priority Data
Dec. 6, 2023 (DE) 10 2023 134 142.1

(51) Int. Cl. H01M 4/88; H01M 4/86; H01M 4/96

(52) U.S. Cl. CPC H01M 4/8817; H01M 2004/8694; H01M 4/96

(57) ABSTRACT

The present disclosure relates to a method of manufacturing a bipolar plate for an electrochemical system. The method comprises the steps of providing at least one metallic plate comprising a plurality of webs and channels formed between the webs, subjecting each of at least two first surface regions of the webs to at least one laser treatment, subjecting each of the at least two first surface regions to an aging process, and coating each of at least one second surface region of the webs located between the at least two first surface regions and immediately adjacent to the at least two first surface regions with at least one graphite coating. In addition, the present disclosure also relates to a bipolar plate for an electrochemical system and an electrochemical system comprising the bipolar plate.

### CROSS REFERENCE TO RELATED APPLICATION

This application claims priority to German Patent Application No. 10 2023 134 142.1, entitled “METHOD OF MANUFACTURING A BIPOLAR PLATE FOR AN ELECTROCHEMICAL SYSTEM AND BIPOLAR PLATE FOR AN ELECTROCHEMICAL SYSTEM”, filed Dec. 6, 2023. The entire contents of the above-identified application is hereby incorporated by reference for all purposes.

### TECHNICAL FIELD

The present disclosure relates to a method of manufacturing a bipolar plate for an electrochemical system. The method comprises the steps of providing at least one metallic plate comprising a plurality of webs and channels formed between the webs, subjecting each of at least two first surface regions of the webs to at least one laser treatment, subjecting each of the at least two first surface regions to an aging process, and coating each of at least one second surface region of the webs located between the at least two first surface regions and immediately adjacent to the at least two first surface regions with at least one graphite coating. In addition, the present disclosure also relates to a bipolar plate for an electrochemical system and an electrochemical system comprising the bipolar plate.

### BACKGROUND AND SUMMARY

Well-known electrochemical systems include fuel cell systems, flow batteries or electrochemical compressor systems, in particular electrolyzers. Known electrolyzers are designed, for example, in such a way that hydrogen and oxygen are generated from water by applying a potential and at least the hydrogen is present in compressed form. In addition, electrochemical compressor systems such as electrochemical hydrogen compressors are also known, to which gaseous molecular hydrogen is fed and in which it is electrochemically compressed by applying a potential. In addition, known electrochemical systems include electrochemical separator systems in which, for example, hydrogen is extracted from one reaction system and enriched in another part of the electrochemical system.

Also known are electrochemical systems comprising a stack of electrochemical cells, each separated from one another by bipolar plates. Such bipolar plates may serve for example for indirectly electrically contacting the electrodes of the individual electrochemical cells (for example fuel cells) and/or for indirectly electrically connecting adjacent cells (series connection of the cells). The bipolar plates may also have a channel structure or may form a channel structure, which is configured to supply the cells with one or more media and/or to remove reaction products. The media may be fuels (for example hydrogen or methanol), reaction gases (for example air or oxygen) or coolants. Such a channel structure is usually located in an electrochemically active region (“flow field”) and in the distribution and collection regions leading to and from it. Furthermore, the bipolar plates may be configured to transport the waste heat that arises when converting electrical and/or chemical energy in the electrochemical cell, and also to seal the various media channels, including the cooling channels, with respect to one another and/or with respect to outside. By way of example, the bipolar plates may have openings, through which the media to be fed and/or the reaction products can be routed towards or away from the electrochemical cells arranged between adjacent bipolar plates of the stack.

The electrochemical cells may for example each comprise one or more membrane electrode assemblies (MEAs). The MEAs may have one or more electrically conductive gas diffusion layers, which are usually oriented towards the bipolar plates and are configured for example as an electrically conductive fleece, for example as a metal or carbon fleece. The bipolar plates are usually composed of two separator plates, each of which adjoins a membrane electrode assembly. Bipolar plates for electrochemical systems usually have a large number of webs and channels arranged between the webs, which serve as the aforementioned channel system or flow field. To improve the electrical properties, these webs can be coated with graphite, for example. For this purpose, graphite can be applied to the webs as a suspension. This is already known, for example, from DE 10 2004 009 869 A1 and DE 10 2007 055 222 A1. However, the process window, in which the viscosity of the suspension and the achievable wet film thickness can be adjusted, is very narrow. The process is therefore technically very demanding. On the one hand, if suspension runs from the webs into the channels, an undefined channel geometry is created. This, and in particular the loss of graphite coating on the webs, leads to a loss of performance of the electrochemical cell(s) or the electrochemical system that is caused by the bipolar plate, and possibly even to leakage.

Based on the above, it is thus the object of the present disclosure to provide a method of manufacturing a bipolar plate comprising a plurality of webs and channels formed between the webs, in which coating of the webs can be carried out with increased accuracy, and to provide a bipolar plate comprising a plurality of webs and channels formed between the webs that can be manufactured in such a way that coating of the webs can be carried out with increased accuracy.

This object is at least partially solved by the method, the bipolar plate, and the electrochemical system described herein.

According to the present disclosure, a method for producing a bipolar plate for an electrochemical system is thus disclosed, in which
at least one metallic plate is provided, which comprises a plurality of webs and channels formed between the webs,
at least two first surface regions of each of the webs are subjected to at least one laser treatment, in which the at least two first surface regions are irradiated by means of a pulsed laser with laser pulses that have a pulse duration of less than 1 ns, wherein the at least one laser treatment produces surface structurings (or surface structuring) on the at least two first surface regions, wherein the surface structurings comprise periodic structures comprising alternately arranged substantially strip-shaped protrusions and depressions, and nanostructures in the form of substantially point-shaped protrusions that are arranged (at least) on the substantially strip-shaped protrusions,
the at least two first surface regions are, after the laser treatment, subjected to an aging process, whereby the surface structurings on the at least two first surface regions age, thereby increasing the areal density of the nanostructures (i.e. the nanostructures in the form of point-shaped protrusions) on the substantially strip-shaped protrusions, and
at least one second surface region of each of the webs, which is arranged between the at least two first surface regions and directly adjoins the at least two first surface regions, is coated with at least one graphite coating, wherein at least one graphite suspension comprising graphite and at least one polar carrier liquid is applied to the at least one second surface region.

With the method according to the present disclosure, it is possible to provide a desired region of the webs of the metallic plate with a graphite coating in a precise manner. For this purpose, hydrophobic, optionally superhydrophobic, surface structurings (for example each surface structuring is a hydrophobic, optionally superhydrophobic, surface structuring) is directly produced on at least two surface regions, i.e. the at least two first surface regions of the web, that are directly adjacent to the region to be coated, i.e. the at least one second surface region of the web, wherein the coating with the at least one graphite coating is ultimately achieved by applying at least one graphite suspension comprising graphite and at least one polar carrier liquid. Because the hydrophobic surface structurings have a repellent effect on the polar carrier liquid, the carrier liquid applied to the region to be coated stops at the edge of the region to be coated, thus immediately adjacent to the at least two first surface regions and does not flow over the at least two surface regions having the surface structurings. The surface structurings thus act as a form of flow stopper for the graphite suspension comprising the graphite and the polar carrier liquid, so that the resulting graphite coating is ultimately only arranged on the region to be coated, i.e. the at least one second surface region. The surface structurings can thus be created on regions that at least partially delimit the region to be coated, so that when the graphite suspension is subsequently applied to the region to be coated, the graphite suspension remains in the region to be coated and does not flow over the regions with the surface structurings into regions that are not to be coated. This ultimately enables very precise application of the graphite suspension and therefore also enables coating of the webs with increased accuracy, because it can be achieved that the coating material actually only reaches the to-be-coated region of the respective web and therefore only this region becomes coated.

In particular, a flow of the suspension from the webs into the channels can be prevented if the regions with the surface structuring are arranged accordingly on the webs, even if, for example, the suspension has a relatively low viscosity and thus a relatively high tendency to flow. Accordingly, performance losses can be avoided that would result from graphite coating becoming arranged in the channels, for example on the channel bottoms, and in particular from a lack of graphite coating on the web surfaces, both of which can result from coating suspension flowing off the webs.

In addition, the process according to the present disclosure simplifies the coating process when applying the graphite suspension, since, for example, the viscosity and the wet layer thickness of the applied graphite suspension no longer have to be adjusted so precisely in order to reduce the risk of the suspension flowing into a region that is not to be coated.

The position of the at least two first surface regions (and thus the position of the surface structuring) is variable and can optionally also be applied in the area with a radius at the transition from the web crest to a web flank or in a strongly inclined section of a web flank. This makes it possible to utilize the maximum available width of the area of the web crest or even part of the width of the area of one or both web flanks and, if the structure is designed in this way over the entire flow field, increases performance over the entire flow field. The crest of the web refers to the region between the web flanks. The crest of the web can be flat (that is, even), at least in sections, especially in its course from web flank to web flank-or arched (that is, curved), or flat (that is, even) in sections and arched (that is, curved) in sections.

Furthermore, the process according to the present disclosure can also be used to produce particularly thick graphite coatings, for example with an average thickness of at least 5 μm, optionally at least 10 μm, since the surface structurings allow a larger quantity of graphite suspension to be applied to the region to be coated without part of the graphite suspension flowing over the regions with the surface structurings. Consequently, a higher wet film thickness and thus also a higher dry film thickness can be achieved than in the prior art.

In particular, the method according to the present disclosure makes it possible to coat curved web crests or inclined web flank sections where the downward slope force would otherwise cause the graphite suspension to cover those regions which here show the surface structurings. Due to the surface structurings, these regions remain free of graphite suspension despite the curvature or inclination. As a result, the graphite suspension cannot flow on to geodesically deeper regions, such as the regions of the channel floors.

Furthermore, the method according to the present disclosure makes it possible to apply the graphite coating to the webs with a high degree of reproducibility, since the applied graphite suspension only wets or covers the intended web regions.

The hydrophobic surface structurings on at least the first two surface regions are obtained by a combination of laser treatment and a subsequent aging process. In the context of the present disclosure, it was surprisingly found that special surface structurings can be obtained by laser treatment on the at least two first surface regions of the webs of the metallic plate, which after an aging process have hydrophobic, optionally superhydrophobic, properties. The special surface structurings obtained by the laser treatment have periodic structures and nanostructures arranged on the periodic structures, wherein the periodic structures comprise alternately arranged substantially strip-shaped protrusions and depressions, and wherein the nanostructures are formed in the form of substantially point-shaped protrusions and are arranged (at least) on the substantially strip-shaped protrusions. As a result of the aging process, the surface structuring on the at least two first surface regions age, whereby the areal density of the nanostructures (i.e. the nanostructures in the form of point-shaped protrusions) on the substantially strip-shaped protrusions increases. The surface structurings obtained in this way ultimately have hydrophobic, optionally superhydrophobic, properties and thus act as a form of flow stopper for the graphite suspension comprising the graphite and the polar carrier liquid, so that the suspension applied to the at least one second surface region stops at the edge of the at least one second surface region (immediately adjacent to the at least two first surface regions) and does not flow onto or over the at least two first surface regions. The first two surface regions, i.e. the regions with surface structuring, therefore remain free of the suspension and thus also free of the coating. This ultimately results in increased accuracy of the coating, as the surface structurings can prevent coating material from reaching regions that are not to be coated.

In step a) of the method according to the present disclosure, at least one metallic plate is provided. The at least one metallic plate has a plurality of webs and channels, with the channels being formed between the webs. The multitude of webs and channels can serve as a flow field or be part of a flow field.

Optionally, the at least one metallic plate comprises two metallic plates. The two metallic plates can also be referred to individually as separator plates. The two metallic plates may (during at least part of steps a) to d) of the method) be connected together, e.g. welded together, or may not be connected together. If the two metallic plates are not connected to each other (during steps a) to d) of the method), the two metallic plates can be connected to each other, e.g. welded together, after step d) to form a bipolar plate.

In step b) of the method according to the present disclosure, at least two first surface regions of the webs are each subjected to at least one laser treatment. In the laser treatment, the at least two first surface regions are irradiated with laser pulses by means of a pulsed laser, the laser pulses having a pulse duration of less than 1 ns. The laser pulses can also be referred to as ultrashort laser pulses. Accordingly, an ultrashort pulse laser (USP laser) can be used as the laser.

The at least one laser treatment produces surface structuring on the at least two first surface regions (that is, a surface structuring is produced on each of the at least two first surface regions). The at least two first surface regions are thus surface-structured surface regions after the at least one laser treatment. The surface structurings have periodic structures and nanostructures.

The periodic structures extend over the entire surface-structured surface regions, i.e. over the entire at least two first surface regions. The two first surface regions may be part of a zone that extends in a closed way, i.e. annularly.

The periodic structures are structures that are arranged periodically in relation to each other in at least one spatial direction. According to some embodiments, the periodic structures can be arranged parallel to one another, at least in sections. The alignment may exist over relatively large or relatively small regions. Different regions with parallel structures, but with a different orientation compared to another region, can also be adjacent to each other. This means that the shape of the periodic structures on the surface is repeated in at least one spatial direction. Periodic structures can generally be characterized by a spatial period. A spatial period typically refers to the maximum distance between two neighboring structures of the same or similar shape, e.g. two of the substantially strip-shaped protrusions or two of the substantially strip-shaped depressions. Due to the manufacturing process, the structures are generally not completely identical to each other. Rather, the period may be subject to fluctuations along the surface, i.e. due to grain boundaries. An average spatial period of the periodic structures may be less than 10 μm, optionally at most 2 μm. It is also possible that the spatial period of the periodic structures is in any case less than 10 μm, optionally at most 2 μm. For example, the periodic structures can have a period in a spatial direction x (parallel to the main extension plane of the surface) of less than 10 μm, optionally of at least 0.3 μm and/or at most 2 μm.

The periodic structures comprise alternately arranged substantially strip-shaped protrusions and depressions, i.e. the periodic structures comprise substantially strip-shaped protrusions and substantially strip-shaped depressions, wherein these protrusions and depressions are arranged alternately or alternately, i.e. the depressions each extend between the (or two of the) protrusions and are bounded and/or formed by them. Substantially strip-shaped can be understood here (and in principle in the context of the entire present disclosure) to mean that a (maximum) length of the respective protrusion or depression is significantly greater, optionally at least 4 times greater, optionally at least 5 times greater, than a (maximum) width of the respective protrusion or depression. The substantially strip-shaped protrusions and/or depressions can each have a linear course and/or a non-linear course, for example a single or multiple curved (e.g. corrugated) course, at least in sections. It is also possible, for example, for the width of the substantially strip-shaped protrusions and/or the width of the substantially strip-shaped depressions to vary along their course. For example, the substantially strip-shaped protrusions and/or depressions can also be partially branched.

In the context of the entire present disclosure, the (maximum) width and/or (maximum) length of the substantially strip-shaped protrusions and/or the (maximum) width and/or (maximum) length of the substantially strip-shaped depressions can be determined, for example, by means of SEM (scanning electron microscopy). The width is typically measured at half height and perpendicular to the local longitudinal direction of the depressions or protrusions. The maximum width can be regarded as the largest width of the respective depression or protrusion that can be measured in this way. The length is typically measured along the longitudinal direction (or course) of the depressions or protrusions. The maximum length can be regarded as the greatest length of the respective depression or protrusion that can be measured in this way.

The nanostructures are in the form of substantially point-shaped protrusions. Furthermore, the nanostructures or the substantially point-shaped protrusions are arranged at least on the substantially strip-shaped protrusions. In addition, the nanostructures in the form of substantially point-shaped protrusions can also be arranged on (or in) the substantially strip-shaped depressions. However, it is possible that the nanostructures in the form of substantially point-shaped protrusions are arranged exclusively on the substantially strip-shaped protrusions. “Substantially point-shaped” can be understood here (and in principle in the context of the entire present disclosure) to mean that the length of the respective protrusion does not differ at all or does not differ significantly from the width of the respective protrusion, the length of the respective protrusion optionally being at most 3 times, optionally at most 2 times, as great as the width of the respective protrusion. A respective circumferential edge of the substantially point-shaped protrusions can, for example, be substantially round (that is, circular), substantially elliptical or substantially oval.

In the context of the entire present disclosure, the length and/or width of the substantially point-shaped protrusions can be determined, for example, by means of SEM (scanning electron microscopy). The length is typically measured along the longest extension direction of the protrusion. The width is typically measured along the direction perpendicular to this longest direction of extension of the protrusion.

Optionally, the nanostructures are arranged in the form of the substantially point-shaped protrusions on the edge regions of the substantially strip-shaped protrusions. Here, the edge region of the respective protrusion represents the entire surface region of the respective protrusion that lies above half the height of the protrusion, measured between the highest point of the protrusion and the lowest point of a neighboring depression. The edge regions of the substantially strip-shaped protrusions can be determined using SEM (scanning electron microscopy), for example.

The at least two first surface regions in sections can each have a linear course and/or a non-linear, for example corrugated, course. For example, the at least two first surface regions overall can each have an essentially linear course or a non-linear, for example corrugated, course.

In step c) of the method according to the present disclosure, the at least two first surface regions according to step b) are subjected to an aging process. The aging process can, for example, take place over a period of at least 10 min, optionally at least 30 min, optionally at least 45 min, optionally at least 1 h, and/or of at most 72 h, optionally at most 50 h, optionally at most 10 h, optionally at most 3 h. The surface structurings on at least the first two surface regions age as a result of the aging process. With this aging process, the areal density of the nanostructures in the form of point-shaped protrusions on the substantially strip-shaped protrusions increases. The areal density of the nanostructures on the substantially strip-shaped protrusions is understood here as the proportion of the total area of the substantially strip-shaped protrusions that the nanostructures in the form of point-shaped protrusions on the substantially strip-shaped protrusions occupy or cover. Optionally, the total area of the substantially strip-shaped protrusions is the sum of the areas of the edge regions of the substantially strip-shaped protrusions. Here, the edge region of the respective protrusion represents the entire surface region of the respective protrusion that lies above half the height of the protrusion when measured as described above.

In step d) of the method according to the present disclosure, at least one second surface region of the webs is coated with at least one graphite coating. Here, at least one graphite suspension is applied to the at least one second surface region. The at least one graphite suspension comprises graphite and at least one polar carrier liquid and may comprise further components, it may be polar taken as a whole. The at least one second surface region is arranged between the at least two first surface regions and is directly adjacent to the at least two first surface regions.

The at least one polar carrier liquid can be a polar solvent, for example. Optionally, the polar carrier liquid has an E_{T}(30) value of at least 170 kJ/mol, optionally at least 180 kJ/mol, optionally at least 190 kJ/mol, optionally at least 200 kJ/mol, optionally at least 210 kJ/mol. The E_{T}(30) value is a measure of the polarity of a liquid or solvent. The E_{T}(30) scale, which comprises the E_{T}(30) values of various solvents, is known as a scale for the polarity of a solvent. It is derived from empirical spectroscopic measurements. The E_{T}(30) value corresponds to the transition energy of the Vis/NIR absorption band with the longest wavelength in a solution with the negative solvatochromic Reichardt dye (betaine 30) at normal conditions (such as 25° C. and 1 bar). Accordingly, the E_{T}(30) value can be determined, for example, by measuring the transition energy of the Vis/NIR absorption band with the longest wavelength in a solution of betaine 30 in the at least one carrier liquid at normal conditions (such as at a temperature of 25° C. and a pressure of 1 bar).

The at least one graphite coating can be formed from the at least one graphite suspension applied, for example by drying and/or at least one heat treatment.

The coating with the at least one graphite coating can in principle be carried out according to methods known in the prior art, in which at least one (polar) graphite suspension comprising graphite and at least one polar carrier liquid is applied, for example as described in DE 10 2004 009 869 A1 or DE 10 2007 055 222 A1.

An embodiment of the method according to the present disclosure is characterized in that
the pulse duration of the laser pulses is less than 100 ps, optionally less than 50 ps, and/or
the fluence (that is, a fluence) introduced into the at least two first surface regions by irradiation with the laser pulses is in a range from 15 J/cm² to 120 J/cm², optionally from 20 J/cm² to 100 J/cm², optionally from 25 J/cm² to 80 J/cm².

In some embodiments, the pulse duration is less than 100 ps, less than 50 ps, less than 20 ps, or even less than 10 ps. In some embodiments, pulse durations in the fs range are used, e.g. greater than 30 fs and/or less than 1000 fs, optionally greater than 50 fs and/or greater than 100 fs. Optionally, picosecond or femtosecond lasers can be used for the method, these being referred to collectively as ultrashort-pulse lasers.

In particular, the surface structuring can be created by the interaction of the incident laser radiation with the irradiated surface. The interaction leads to a spatially modulated energy coupling into the material, which subsequently leads to surface structuring, which then ages as a result of the aging process. Typically, a or the fluence of the laser radiation is in the order of magnitude of the ablation threshold of the metallic plate material used. The fluence can be selected, for example, so that it deviates by no more than 20% from the ablation threshold of the material used for the at least one metallic plate. The fluence is a measure of the energy density of the laser pulses and is usually specified in J/cm². The fluence can optionally be at least 15 J/cm², optionally at least 20 J/cm², optionally at least 25 J/cm², and/or at most 120 J/cm², optionally at most 100 J/cm², optionally 80 J/cm².

A further embodiment of the method according to the present disclosure is characterized in that the aging process takes place
at a temperature of at least 10° C., optionally at least 50° C., optionally at least 80° C. and/or at a temperature of at most 150° C., optionally at most 120° C., optionally at most 90° C., and/or
at a humidity of at least 40%, optionally at least 60%, optionally at least 70% and/or a humidity of at the most of 100%, optionally at the most 95%, optionally at the most 90%, and/or
over a duration of 10 min to 72 h, optionally from 30 min to 50 h, optionally from 45min to 10 h, optionally from 1 h to 3 h, optionally from 6 h to 60 h, optionally from 12 h to 55 h, optionally from 24 h to 52 h.

A further embodiment of the method according to the present disclosure is characterized in that the aging process takes place
at a temperature of at least 10° C., optionally at least 50° C., optionally at least 80° C., and/or at most 150° C., optionally at most 120° C., optionally at most 90° C., and/or
at a humidity of at least 40%, optionally at least 60%, optionally at least 70%, and/or at most 100%, optionally at most 95%, optionally at most 90%, and/or
for a duration of at least 10 min, optionally at least 30 min, optionally at least 45 min, optionally at least 1 h, optionally at least 6 h, optionally at least 12 h, optionally at least 24 h and/or at most 72 h, optionally at most 60 h, optionally at most 55 h, optionally at most 52 h, optionally at most 50 h, optionally at most 10 h, optionally at most 3 h.

A further embodiment of the method according to the present disclosure is characterized in that
the substantially strip-shaped protrusions have a width in the range from 250 nm to 700 nm, optionally from 350 nm to 600 nm, and/or the substantially strip-shaped depressions have a width in the range from 100 nm to 550 nm, optionally from 200 nm to 450 nm, and/or
the nanostructures (in each case) have an average diameter in the range from 10 nm to 200 nm, optionally from 30 nm to 150 nm, optionally from 50 nm to 120 nm, and/or
the nanostructures (in each case) have a maximum diameter in the range from 10 nm to 300 nm, optionally from 30 nm to 250 nm, optionally from 50 nm to 200 nm, and/or
the nanostructures each have a surface region in the range from 80 nm² to 40,000 nm², optionally from 800 nm² to 20,000 nm², optionally from 2,000 nm² to 10,000 nm².

The width of the substantially strip-shaped protrusions and/or the width of the substantially strip-shaped depressions can be determined using SEM (scanning electron microscopy), for example. The width is typically measured at half height and perpendicular to the local longitudinal direction of the depressions or protrusions. For example, the width of the substantially strip-shaped protrusions can vary along the course of the individual protrusions. For example, the width of the substantially strip-shaped depressions can vary along the course of the individual depressions.

Optionally, the substantially strip-shaped depressions can have a depth in the range of 0.05 to 0.7 μm. The depth refers to the extension perpendicular to the plate plane below half the height. Accordingly, the substantially strip-shaped protrusions can have a height in the range of 0.05 to 0.7 μm. The height refers to the extension perpendicular to the plate plane above half the depth. This depth and height can be determined using SEM (scanning electron microscopy), for example, FIB SEM (scanning electron microscopy with focused ion beam). The height or depth is usually measured perpendicular to the surface formed by the substantially strip-shaped protrusions or the strip-shaped depressions. For example, the depth as well as the height can vary along the course of the individual depressions and/or protrusions.

The (respective) average diameter and the (respective) maximum diameter of the nanostructures can be determined using SEM (scanning electron microscopy), for example. The diameter is typically measured as a (linear) spatial distance running through the center of the respective nanostructure between a first point of the outer edge of the respective nanostructure and a second point of the outer edge of the nanostructure opposite the first point. The average diameter can then be determined by averaging several measured diameter values (each for one nanostructure). For example, the nanostructures can (in each case) have a minimum diameter in the range from 5 to 60 nm, optionally from 10 to 55 nm, optionally from 15 to 50 nm. Optionally, the average diameter of the individual nanostructures can vary over a certain bandwidth, i.e. the nanostructures can be of different sizes.

The respective surface area of the nanostructures can be determined using SEM (scanning electron microscopy), for example. The area size of a nanostructure can be understood as the size of the area that the nanostructure covers or occupies in the top view of the surface on which it is located. Optionally, the surface area of the individual nanostructures can vary over a certain bandwidth, i.e. the nanostructures can be of different sizes.

A further embodiment of the method according to the present disclosure is characterized in that the areal density of the nanostructures on the substantially strip-shaped protrusions
before the aging process is in the range from 0.3 to 5%, optionally from 0.5 to 4%, and/or
after the aging process is in the range of 1 to 10%, optionally 2 to 6%.

The areal density of the nanostructures can, for example, be determined using SEM (scanning electron microscopy). The areal density of the nanostructures on the substantially strip-shaped protrusions is understood to be the proportion of the total area of the substantially strip-shaped protrusions that the nanostructures in the form of point-shaped protrusions on the substantially strip-shaped protrusions occupy or cover. Optionally, the total area of the substantially strip-shaped protrusions is the sum of the areas of the edge regions of the substantially strip-shaped protrusions as defined above.

According to a further embodiment of the method according to the present disclosure, the at least one metallic plate is formed from stainless steel and/or at least one titanium alloy, for example from a stainless-steel core with at least one surface of a titanium alloy.

A further embodiment of the method according to the present disclosure is characterized in that the coating of the at least one second surface region with the at least one graphite coating is carried out by a method selected from the group consisting of screen printing methods, roller printing methods, stencil printing methods, and combinations thereof.

A further embodiment of the method according to the present disclosure is characterized in that
substantially parallel to (that is, along) a main direction of extension of the respective web and/or extend over the entire length of the respective web, and/or
the at least two first surface regions each have a width (over the entire length of the respective surface region) in the range from 90 μm to 460 μm, optionally from 95 μm to 300 μm, optionally from 100 μm to 200 μm.

The respective width of the at least two first surface regions can be determined using SEM (scanning electron microscopy), for example. The width is typically measured perpendicular to the local longitudinal direction of the respective surface region. For example, it is possible that the respective width of the at least two first surface regions varies along their course.

A further embodiment of the method according to the present disclosure is characterized in that the webs each have a web crest (extending along the main direction of extension of the web) and a first and a second web flank (extending along the main direction of extension of the web) respectively adjacent to the web crest, wherein
at least one of the at least two first surface regions is arranged on the first web flank, optionally on an edge of the first web flank directly adjoining the web crest, and/or on the web crest, optionally on an edge of the web crest directly adjoining the first web flank, and at least one further first surface region of the at least two first surface regions is arranged on the second web flank, optionally on an edge of the second web flank directly adjoining the web crest, and/or on the web crest, optionally on an edge of the web crest directly adjoining the second web flank, and/or
the at least one second surface region is arranged on the web crest, wherein the at least one second surface region optionally extends over the entire width (extending perpendicular to the main direction of extension of the web) of the web crest, wherein the at least one second surface region extends optionally over the entire width (extending perpendicular to the main direction of extension of the web) of the web crest and additionally over a part of the first and/or the second web flank.

The fact that the at least one of the at least two first surface regions is arranged on an edge of the first web flank directly adjacent to the web crest and at least one other of the at least two first surface regions is arranged on an edge of the second web flank directly adjacent to the web crest means that the entire web crest is coated (that is, the web crest is coated over the entire width) without any of the graphite suspension reaching the web flanks.

The at least one second surface region may extend over the entire width (perpendicular to the main direction of extension of the web) of the web crest and additionally over a part of the first and second web flank. This makes it possible to utilize the maximum available width of the area of the web crest and, if the structure is designed in this way over the entire flow field, thus improves performance over the entire flow field.

Optionally, the web crest of the respective web has no curvature (that is, the web crest of the respective web is flat) or the web crest of the respective web has a curvature with a radius of at least 1.5 mm, optionally of at least 3 mm, optionally of at least 5 mm.

Optionally, the web flanks of the respective web each have a minimum angle to the zero plane in the range from 15° to 75°, optionally from 25° to 65°. Here, the zero plane is understood to be the main extension plane of the metallic plate.

Optionally, the web flanks of the respective web are tangentially connected to the web crest of the respective web with a radius of at least 0.05 mm, optionally at least 0.2 mm. This radius can be considered as part of the web flank or as a transition between the web crest and the web flank.

Optionally, the web flanks of the respective web are each tangentially connected to the base of the channel adjacent to the respective web flank with a radius of at least 0.05 mm, optionally at least 0.2 mm.

A further embodiment of the process according to the present disclosure is characterized in that after step d) at least one (porous) diffusion layer, optionally a gas diffusion layer, is brought into contact with the at least one graphite coating. This can lead to a defined interaction between the graphite coating and the fibers of the diffusion layer. Optionally, it is also possible for sections of the at least one diffusion layer to co-crosslink with the graphite coating.

Furthermore, the present disclosure also relates to a bipolar plate for an electrochemical system comprising at least one metallic plate having a plurality of webs and channels formed between the webs, wherein the webs each have at least two first surface regions and at least one second surface region arranged between the at least two first surface regions and directly adjoining the at least two first surface regions, wherein the at least two first surface regions have surface structurings, that is, each first surface region has a surface structuring, which comprise periodic structures that are arranged alternately in the form of substantially strip-shaped protrusions and depressions, and nanostructures in the form of substantially point-shaped protrusions that are arranged at least on the substantially strip-shaped protrusions, and wherein the at least one second surface region is at least one surface region coated with at least one graphite coating that is, at least one surface region having at least one graphite coating.

Due to the fact that the at least two first surface regions have surface structurings (that is, each first surface region has one surface structuring), the at least two first surface regions are surface-structured surface regions. Optionally, the at least two first surface regions are at least two laser-treated surface regions.

The surface structuring maybe produced by at least one laser treatment and at least one subsequent aging process. The at least one laser treatment and/or the at least one aging process may have been carried out in accordance with the respective previously described embodiments relating to the method according to the present disclosure.

In addition, the at least one graphite coating may be produced by a process in which at least one polar graphite suspension comprising graphite and at least one polar carrier liquid is applied to the at least one second surface region. The at least one graphite suspension can optionally be applied using a process selected from the group consisting of screen printing processes, roller printing processes, stencil printing processes, and combinations thereof.

The plurality of webs and channels can serve as a flow field or be part of a flow field.

The surface structurings have periodic structures and nanostructures. The periodic structures extend over the entire surface-structured surface regions, i.e. over the entire at least two first surface regions.

The periodic structures and the nanostructures are formed or can be formed as previously described in the context of the method according to the present disclosure, the explanations there applying analogously here.

Since the bipolar plate according to the present disclosure is based on at least one metallic plate, it can also be referred to as a metallic bipolar plate. The bipolar plate according to the present disclosure may comprise two such metallic plates.

Optionally, the at least one metallic plate comprises two metallic plates that are joined together, e.g. welded together. The two metallic plates can also be referred to as separator plates.

An embodiment of the bipolar plate according to the present disclosure is characterized in that
the substantially strip-shaped protrusions have a width in the range from 250 nm to 700 nm, optionally from 350 nm to 600 nm, and/or the substantially strip-shaped depressions have a width in the range from 100 nm to 550 nm, optionally from 200 nm to 450 nm, and/or
the nanostructures (in each case) have an average diameter in the range from 10 nm to 200 nm, optionally from 30 nm to 150 nm, optionally from 50 nm to 120 nm, and/or
the nanostructures (in each case) have a maximum diameter in the range from 10 nm to 300 nm, optionally from 30 nm to 250 nm, optionally from 50 nm to 200 nm, and/or
the nanostructures each have a surface region in the range from 80 nm² to 40,000 nm², optionally from 800 nm² to 20,000 nm², optionally from 2,000 nm² to 10,000 nm², and/or
the areal density of the nanostructures on the substantially strip-shaped protrusions is in the range from 1 to 10%, optionally from 2 to 6%.

The width of the substantially strip-shaped protrusions and/or the width of the substantially strip-shaped depressions can be determined, for example, as described in the context of the method according to the present disclosure.

The (respective) average diameter and the (respective) maximum diameter of the nanostructures can be determined, for example, as described in the context of the method according to the present disclosure.

The respective area size of the nanostructures can be determined, for example, as described in the context of the method according to the present disclosure, whereby what is said in the context of the method according to the present disclosure with regard to variations and bandwidths or ranges applies analogously.

The areal density of the nanostructures can be determined, for example, as described in the context of the method according to the present disclosure, whereby the explanations there apply analogously here.

According to a further embodiment of the bipolar plate according to the present disclosure, the at least one metallic plate is formed from stainless steel and/or at least one titanium alloy, for example from a stainless-steel core with at least one surface made of a titanium alloy.

A further embodiment of the bipolar plate according to the present disclosure is characterized in that
substantially parallel to (that is, along) a main direction of extension of the respective web and/or extend over the entire length of the respective web, and/or
the at least two first surface regions each have a width (over the entire length of the respective surface region) in the range from 90 μm to 460 μm, optionally from 95 μm to 300 μm, optionally from 100 μm to 200 μm.

The respective width of the at least two first surface regions can be determined, for example, as described in the context of the method according to the present disclosure. For example, it is possible that the respective width of the at least two first surface regions varies along their course.

An embodiment of the bipolar plate according to the present disclosure is characterized in that the webs each have a web crest (extending along the main direction of extension of the web) and a first and a second web flank (extending along the main direction of extension of the web) respectively adjacent to the web crest, wherein
at least one of the at least two first surface regions is arranged on the first web flank, optionally on an edge of the first web flank directly adjoining the web crest, and/or on the web crest, optionally on an edge of the web crest directly adjoining the first web flank, and at least one further first surface region of the at least two first surface regions is arranged on the second web flank, optionally on an edge of the second web flank directly adjoining the web crest, and/or on the web crest, optionally on an edge of the web crest directly adjoining the second web flank, and/or
the at least one second surface region is arranged on the web crest, wherein the at least one second surface region optionally extends over the entire width of the web crest (extending perpendicularly to the main direction of extension of the web), wherein the at least one second surface region extends optionally over the entire width of the web crest (extending perpendicularly to the main direction of extension of the web) and additionally in each case over a part of the first and/or the second web flank.

The at least one second surface region may extend over the entire width (perpendicular to the main direction of extension of the web) of the web crest and additionally over a part of the first and second web flank. This makes it possible to utilize the maximum available width of the area of the web crest for direct contact with an adjacent diffusion layer and, if the structure is designed in this way over the entire flow field, thus the electrochemically active area of the plate, this enables an improved performance over the entire flow field.

The web crest(s) and/or the web flanks can be configured as previously described in the context of the method according to the present disclosure, whereby the explanations there apply analogously here.

A further embodiment of the bipolar plate according to the present disclosure is characterized in that the bipolar plate comprises at least one (porous) diffusion layer, optionally a gas diffusion layer, which is in contact with the at least one graphite coating. This can lead to a defined interaction between the graphite coating and the fibers of the diffusion layer. In addition, it is possible for sections of the at least one diffusion layer to be co-crosslinked with the graphite coating.

According to a further embodiment of the bipolar plate according to the present disclosure, the at least one graphite coating has an average thickness of at least 5 μm, optionally at least 10 μm.

A further embodiment of the bipolar plate according to the present disclosure is characterized in that the bipolar plate can be produced using the method according to the present disclosure.

The present disclosure also relates to an electrochemical system comprising at least one bipolar plate according to the present disclosure. Optionally, the electrochemical system is an electrochemical cell, e.g. a fuel cell, or a stack comprising several electrochemical cells, e.g. a fuel cell stack.

The method according to the present disclosure can be used to manufacture the bipolar plate according to the present disclosure.

The following figures and examples are intended to explain the present disclosure in more detail, without limiting it to the specific embodiments and parameters shown here.

### BRIEF DESCRIPTION OF THE FIGURES

FIG. 1 schematically shows a perspective view of an electrochemical system with a large number of bipolar plates arranged in a stack.

FIG. 2 schematically shows a perspective view of two bipolar plates of the system according to FIG. 1 with a membrane electrode assembly (MEA) arranged between the bipolar plates.

FIG. 3A schematically shows a cross-section through a section of an electrochemical system 1 according to the prior art of the type of system 1 shown in FIG. 1 and FIG. 2.

FIG. 3B shows an enlarged view of section III from FIG. 3A.

FIG. 4A schematically shows a cross-section through a section of an electrochemical system 1 of the type of system 1 in FIG. 1 and FIG. 2.

FIG. 4B shows an enlarged view of section IV from FIG. 4A.

FIG. 5A shows an SEM image of the surface structuring of one of the first surface regions before the aging process.

FIG. 5B an enlarged view of a section of the SEM image from FIG. 5A.

FIG. 6A shows an SEM image of the surface structuring of one of the first surface regions after the aging process.

FIG. 6B an enlarged view of a section of the SEM image from FIG. 6A.

FIG. 7 shows an SEM image of the surface structuring of one of the first surface regions.

FIG. 8 schematically shows a cross-section through a section of a further electrochemical system 1 of the type of system 1 in FIG. 1 and FIG. 2.

FIG. 9A schematically shows a cross-section of a section of a metallic plate 2c during the implementation of an exemplary embodiment of the method according to the present disclosure for producing a bipolar plate 2.

FIG. 9B schematically shows a cross-section of a section of a metallic plate 2c during the implementation of an exemplary embodiment of the method according to the present disclosure for producing a bipolar plate 2.

FIG. 9C schematically shows a cross-section of a section of a metallic plate 2c during the implementation of an exemplary embodiment of the method according to the present disclosure for producing a bipolar plate 2.

FIG. 10 schematically shows a perspective view of a section of a metallic plate 2c during the implementation of an exemplary embodiment of the method according to the present disclosure for producing a bipolar plate 2.

FIG. 11A schematically shows a top view of a section of a metallic plate 2c, as shown in FIG. 10.

FIG. 11B schematically shows a top view of a section of a metallic plate 2c as shown in FIG. 10.

FIG. 12 shows a flow chart of the method according to the present disclosure.

### DETAILED DESCRIPTION

Here and below, features that recur in different figures are denoted in each case by the same or similar reference signs.

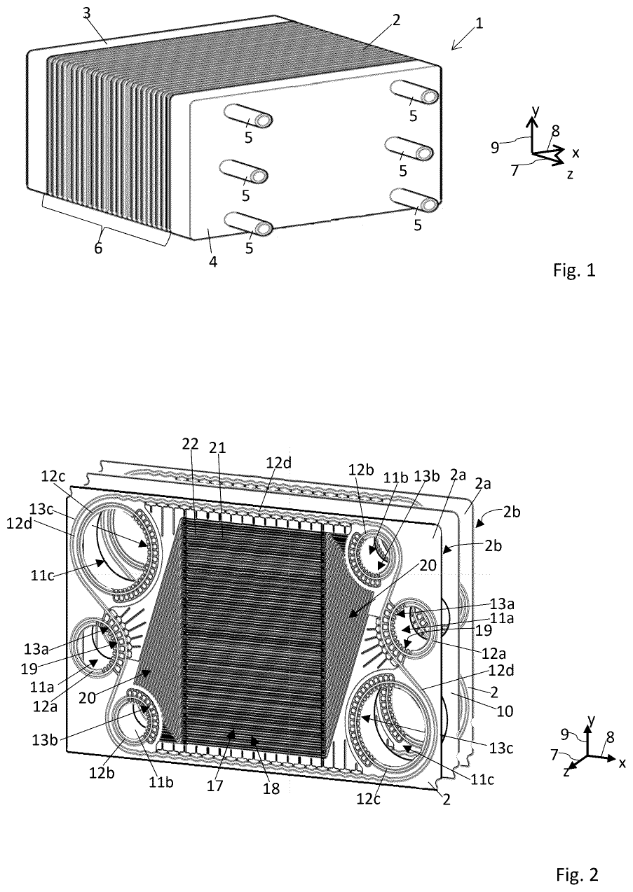

FIG. 1 shows an electrochemical system 1 with a plurality of identically constructed metallic bipolar plates 2, which are arranged in a stack 6 and are stacked along a z-direction 7. The bipolar plates 2 of the stack 6 are clamped between two end plates 3, 4. The z-direction 7 is also called the stacking direction. In the present example, the system 1 is a fuel cell stack. Each two adjacent bipolar plates 2 or the facing separator plates 2a, 2b of each of these bipolar plates 2 of the stack thus delimit an electrochemical cell, which is used, for example, to convert chemical energy into electrical energy. To form the electrochemical cells of system 1, a membrane electrode assembly (MEA) is arranged between adjacent bipolar plates 2 of the stack (see e.g. FIG. 2). The MEA typically contains at least one membrane, e.g. an electrolyte membrane. Furthermore, a gas diffusion layer (GDL) can be arranged on one or both surfaces of the MEA, which is adjacent to the surface of a separator plate 2a, 2b.

In alternative embodiments, the system 1 may equally be in the form of an electrolyzer, an electrochemical compressor or a redox flow battery. Bipolar plates can likewise be used in these electrochemical systems. The structure of these bipolar plates may then correspond to the structure of the bipolar plates 2 explained in detail here, although the media guided on and/or through the bipolar plates in the case of an electrolyzer, an electrochemical compressor or a redox flow battery may differ in each case from the media used for a fuel cell system. Further, dependent on the kind of electrochemical system, the bipolar plates 2 may comprise one or more plates.

The z-axis 7, together with an x-axis 8 and a y-axis 9, spans a right-handed Cartesian coordinate system. The bipolar plates 2 each define a plate plane, each of the plate planes of the separator plates 2a, 2b of the bipolar plates 2 being oriented parallel to the x-y plane and thus perpendicular to the stacking direction or to the z-axis 7. The end plate 4 comprises a plurality of media connections 5, via which media can be fed to the system 1 and via which media can be discharged from the system 1. These media that can be supplied to and discharged from system 1 can include, for example, fuels such as molecular hydrogen or methanol, reaction gases such as air or oxygen, reaction products such as water vapor or depleted fuels, or coolants such as water and/or glycol.

FIG. 2 shows, in a perspective view, two adjacent bipolar plates 2 of an electrochemical system of the same type as the system 1 from FIG. 1, as well as a membrane electrode assembly (MEA) 10 known from the prior art that is arranged between said adjacent bipolar plates 2, the MEA 10 in FIG. 2 being largely concealed by the bipolar plate 2 facing towards the viewer. The bipolar plate 2 is formed of two separator plates 2a, 2b that are joined together in a materially bonded manner, of which only the first separator plate 2a facing towards the viewer is visible in FIG. 2, said first separator plate obscuring the second separator plate 2b. The separator plates 2a, 2b can each be made from a metal sheet, e.g. a stainless-steel sheet. The separator plates 2a, 2b can, for example, be welded together along and at a distance from their edges, e.g. by laser welding joints.

In an electrochemically active region 18, the first separator plates 2a have, on the front side thereof facing towards the viewer of FIG. 2, a flow field 17 with structures for guiding a reaction medium along the front side of the separator plate 2a. These structures are given in FIG. 2 by a plurality of webs 21 and channels 22 extending between the webs 21 and delimited by the webs 21.

The separator plates 2a, 2b have through-openings, which are aligned with one another and form the through-openings 11a-c of the bipolar plate 2. When stacking a plurality of bipolar plates of the type of bipolar plate 2, the through-openings 11a-c form ducts that extend through the stack 6 in the stacking direction (or z-direction 7) (see FIG. 1). Typically, each of the ducts formed by the through-openings 11a-c is fluidically connected to one of the media ports 5 in the end plate 4 of the system 1.

On the front side of the bipolar plates 2 facing towards the viewer of FIG. 2, the first separator plates 2a additionally have a distribution or collection region 20. The distribution or collection region 20 comprises structures which are configured to distribute over the active region 18 a medium that is introduced into the distribution or collection region 20 from a first of the two passage openings 11b, and/or to collect or to pool a medium flowing towards the second of the passage openings 11b from the active region 18. In FIG. 2, the distribution structures of the distribution or collection region 20 are likewise provided by webs and by channels that extend between the webs and are delimited by the webs. In general, the elements 17, 18, 20, 21, 22 can therefore be understood as media-conducting embossed structures formed integrally with the separator plates 2a, 2b.

In order to seal off the through-openings 11a-c with respect to the interior of the stack 6 and with respect to the surrounding environment, the first separator plates 2a usually have sealing arrangements in the form of sealing beads 12a-c, which are each arranged around the through-openings 11a-c and in each case completely surround the through-openings 11a-c. On the rear side of the bipolar plates 2, facing away from the viewer of FIG. 2, the second separator plates 2b have corresponding sealing beads for sealing off the through-openings 11a-c (not shown).

The sealing beads 11a-c each have fluid passages 13a-c for passing fluid. By way of the ducts formed by the through-openings 11a, it is possible for coolant to be introduced into the stack or discharged from the stack by means of the passages 13a, in particular into or out of the space 19 between the separator plates 2a, 2b. By contrast, the ducts formed by the through-openings 11b, 11c may be configured, by way of the passages 13b, 13c, to supply the electrochemical cells of the fuel cell stack 6 of the system 1 with fuel and with reaction gas and to discharge the reaction products from the stack. The media-guiding through-openings 11a-c are substantially parallel to the plate plane.

The first separator plates 2a typically also each have a further sealing bead 12d in the form of a perimeter bead, which runs around the flow field 17 of the active region 18, the distribution or collection region 20 and the through-openings 11b, 11c and seals these from the through-opening 11a, i.e. from the coolant circuit and from the external environment of the system 1. The second separator plates 2b each comprise corresponding perimeter beads.

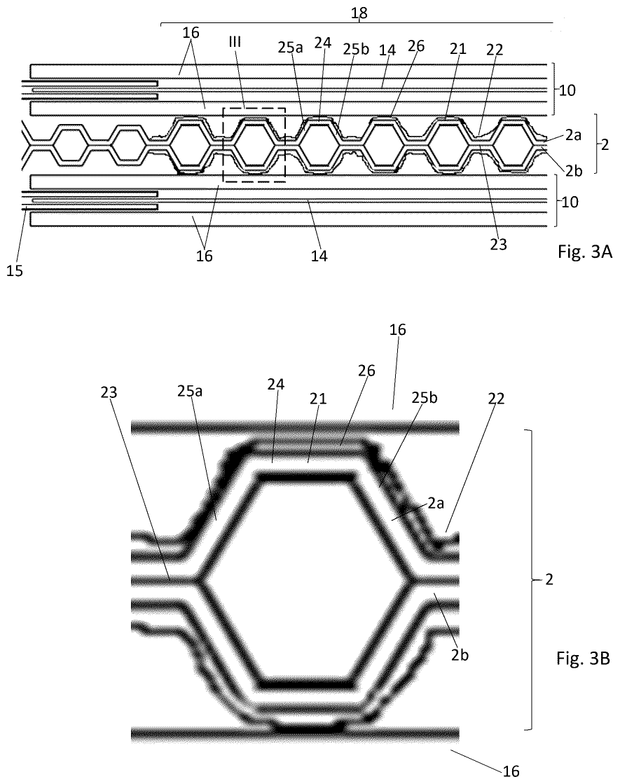

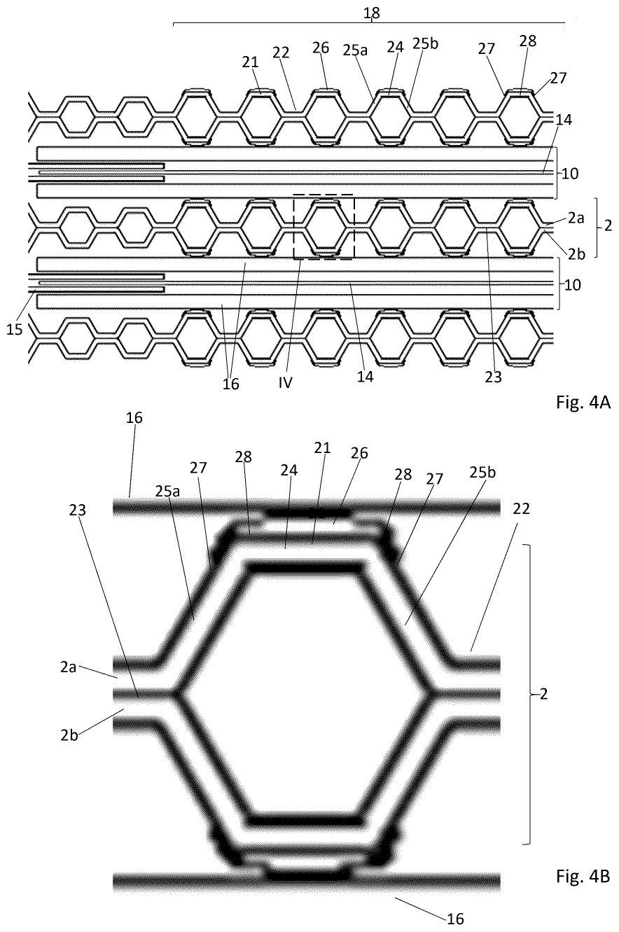

FIG. 3A and FIG. 4A each show a schematic section through a section of an electrochemical system 1 of the type of system 1 in FIG. 1 and FIG. 2, the sectional plane in each case being aligned in the z-direction and thus perpendicular to the plate planes of the bipolar plates 2. The electrochemical system in FIG. 3A differs from the electrochemical system in FIG. 4A with regard to the bipolar plates. Thus, the bipolar plates of the electrochemical system in FIG. 3A are bipolar plates according to the prior art or bipolar plates manufactured according to the prior art, whereas the bipolar plates of the electrochemical system in FIG. 4A are exemplary bipolar plates according to the present disclosure or bipolar plates produced according to an exemplary embodiment of the method according to the present disclosure. The individual bipolar plates of the electrochemical system in FIG. 3A are identical in construction. The individual bipolar plates of the electrochemical system in FIG. 4A are also identical to each other.

The bipolar plates 2 of the system in FIG. 3A and the bipolar plates 2 of the system in FIG. 4A each comprise the first metallic separator plate 2a described above and the second metallic separator plate 2b described above. Each metallic separator plate 2a, 2b can have a thickness of about 75 μm. Structures for media conduction can be seen along the outer surfaces of the bipolar plates 2 in the form of webs 21 and channels 22 bounded by the webs 21. The two separator plates 2a, 2b lie on top of each other in a contact region 23 and can be connected to each other there, for example by means of laser welding seams. The metallic separator plates 2a, 2b can, for example, be formed from stainless steel and/or at least one titanium alloy, for example from a stainless-steel core with at least one surface made of a titanium alloy.

In the section shown in FIG. 3A, a bipolar plate 2 is shown arranged between two membrane electrode assemblies (MEA) 10. The section shown in FIG. 4A shows three bipolar plates 2, with a membrane electrode assembly (MEA) 10 arranged between each two of the bipolar plates 2. The MEA 10 typically comprises a membrane 14, e.g. an electrolyte membrane, and a sealing edge region 15 connected to the membrane. For example, the sealing edge region 15 can be bonded to the membrane 14, e.g. by an adhesive connection or by lamination.

The membrane of the MEA 10 extends in each case at least over the active region 18 of the adjoining bipolar plates 2 and there enables a proton transfer via or through the membrane. The membrane does not extend into the distribution or collection region 20. The sealing edge region 15 of the MEA 10 serves in each case for positioning, fastening and sealing off the membrane between the adjoining bipolar plates 2.

Furthermore, gas diffusion layers 16 may additionally be arranged in the active region 18. The gas diffusion layers 16 enable a flow across the membrane 14 over the largest possible region of the surface of the membrane 14 and can thus improve the proton transfer via the membrane 14. The gas diffusion layers 16 can, for example, be arranged on both sides of the membrane 14 in the active region 18 between the adjacent separator plates 2. The gas diffusion layers 16 can, for example, be formed from an electrically conductive fleece or comprise an electrically conductive fleece. The electrically conductive fleece may be a metal fleece or a carbon fleece.

FIG. 3B now shows an enlarged view of section III from FIG. 3A, which shows one of the webs 21 between two channels 22. Accordingly, FIG. 4B shows an enlarged view of section IV from FIG. 4A, which shows one of the webs 21 between two channels 22. The webs 21 each have a web crest 24 extending along the main direction of extension of the respective web as well as a first and a second web flank 25a and 25b each adjoining the web crest 24 and extending along the main direction of extension of the respective web.

The web crests 24 of the webs 21 shown in FIG. 3A/B and FIG. 4A/B have no curvature (that is, are flat), but can alternatively also have a curvature with a radius of at least 3 mm, optionally of at least 5 mm.

Optionally, the web flanks 25a and 25b of the respective web 21 each have a minimum angle to the zero plane in the range from 15° to 75°, optionally from 25° to 65°. Here, the zero plane is understood to be the main extension plane of the metallic plates 2a or 2b.

Optionally, the web flanks 25a and 25b of the respective web 21 are tangentially connected to the web crest 24 of the respective web 21 with a radius which is at least 0.05 mm, optionally at least 0.2 mm. This radius can be considered part of the web flank 25a, 25b.

Optionally, the web flanks 25a and 25b of the respective web 21 are each tangentially connected to the bottom of the channel 22 adjacent to the respective web flank 25a, 25b with a radius which is at least 0.05 mm, optionally at least 0.2 mm. This radius can also be considered part of the web flank 25a, 25b.

As already mentioned, the bipolar plates 2 of the electrochemical system in FIG. 3A/B are bipolar plates according to the priorart or bipolar plates manufactured according to the prior art. Here, the bipolar plate 2 in FIG. 3A/B has a graphite coating 26, which was produced by applying a graphite suspension to the web crests 24 of the webs 21. During and/or after the suspension has been applied, it has flowed from the webs 21 into the channels 22. As a result, the graphite coating now covers not only the surface of the webs 21, but also surface sections of the web flanks 25a, 25b and the surface of the channels 22. As a result, however, the bipolar plates 2 and thus the entire electrochemical system in FIG. 3A/B exhibit power losses due to reduced graphite coating thickness on the web surfaces. FIG. 3B shows an example in which, due to a reduced graphite coating thickness, there is no planar contact between the coating 26 of the upper separator plate 2a and the gas diffusion layer 16, since a large part of the graphite coating material has flowed into the channels 22.

In contrast to the bipolar plates 2 of the electrochemical system of FIG. 3A/B, the bipolar plates 2 of the electrochemical system of FIG. 4A/B are now exemplary bipolar plates according to the present disclosure or bipolar plates produced using an exemplary embodiment of the method according to the present disclosure. The webs 21 of these bipolar plates 2 each have two first surface regions 27 and a second surface region 28 arranged between the two first surface regions 27 and directly adjacent to the two first surface regions 27. The second surface region 28 is in each case coated with a graphite coating 26 and extends over the entire width of the web crest 24 and over a part of the first web flank 25a and the second web flank 25b in each case. One of the two first surface regions 27 is disposed on the first web flank 25a and the other of the two first surface regions 27 is disposed on the second web flank 25b, each of the two first surface regions 27 being immediately adjacent to the graphite-coated second surface region 28. In addition, the two first surface regions 27 and the second surface region 28 extend substantially parallel to a main direction of extension of the respective web 21 and may extend over the entire length of the respective web 21. The two first surface regions 27 can each have a width in the range from 90 μm to 460 μm, optionally from 95 μm to 300 μm, optionally from 100 μm to 200 μm.

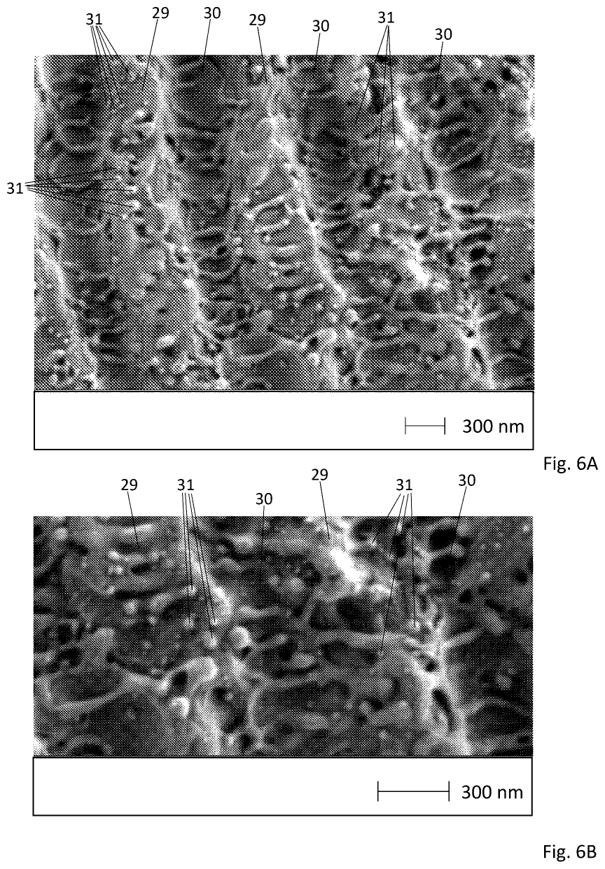

The two first surface regions 27 each have a special surface structuring. FIG. 6A shows an SEM image of such a surface structuring. FIG. 6B also shows an enlarged view of the SEM image from FIG. 6A. The surface structurings of the two first surface regions 27 have periodic structures and nanostructures 31, wherein the periodic structures comprise alternately arranged substantially strip-shaped protrusions 29 and depressions 30 and wherein the nanostructures 31 are formed in the form of substantially point-shaped protrusions and are arranged (at least) on the substantially strip-shaped protrusions 29. These special surface structurings now make it easier to apply the graphite suspension during the manufacture of the bipolar plates 2. The special surface structurings have hydrophobic, optionally superhydrophobic, properties and thus, during the production of the bipolar plate 2, act as a form of flow stopper for a polar graphite suspension comprising graphite and a polar carrier liquid and may optionally comprise at least one further component, alternatively, the suspension may consist of graphite, a polar carrier liquid and optionally at least one further component), so that such a graphite suspension applied to the second surface region 28 stops at the edge of the second surface region 28 immediately adjacent to the two first surface regions 27 and does not flow onto or over the two first surface regions 27. The surface structurings thus act as a form of flow stopper for the graphite suspension comprising the graphite and the polar carrier liquid, so that the graphite coating 26 is ultimately only arranged on the second surface region 28. This enables a very precise application of the graphite suspension and thus also a coating of the webs 21 with increased accuracy, since it can be achieved that the coating material actually only reaches the region of the respective web 21 to be coated, i.e. in the present example the second surface region 28, and thus only this region is coated. In particular, in the present example, the surface structurings on the webs 21 can prevent the suspension from flowing from the webs 21 into the channels 22, even if, for example, the suspension has a relatively low viscosity and thus a relatively high tendency to flow. Accordingly, in the bipolar plates of the electrochemical system in FIG. 4A/B, the graphite coating 26 is only arranged on the webs 21 and not in the channels 22. As a result, performance losses that would occur due to graphite coating being present in the channels, for example on the channel bottoms, and in particular due to a lack of graphite coating on the web surfaces, and which occur in the electrochemical system in FIG. 3A/B, can be avoided.

In addition, the special surface structurings simplify the application of the graphite suspension during graphite coating, as the viscosity and the wet layer thickness of the applied graphite suspension no longer have to be adjusted so precisely in order to reduce the risk of the suspension flowing into a region that is not to be coated.

Due to the special surface structurings, the graphite coating 26 on the respective webs 21 can also have a particularly high thickness, e.g. an average thickness of at least 5 μm, optionally at least 10 μm, since the surface structurings allows a larger amount of graphite suspension to be applied to the region to be coated without some of the graphite suspension flowing off. Consequently, a higher wet film thickness and thus also a higher dry film thickness can be achieved than in the prior art.

The special surface structurings can be produced by laser treatment and a subsequent aging process. In the laser treatment, the two first surface regions 27 are irradiated by means of a pulsed laser with laser pulses having a pulse duration of less than 1 ns, optionally less than 100 ps, optionally less than 50 ps. Optionally, picosecond or femtosecond lasers, which are collectively referred to as ultrashort pulse lasers, can be used for laser treatment. Optionally, the fluence introduced into the two first surface regions by irradiation with the laser pulses is in a range from 15 J/cm² to 120 J/cm², optionally from 20 J/cm² to 100 J/cm², optionally from 25 J/cm² to 80 J/cm². The aging process can, for example take place
at a temperature in the range from 10° C. to 150° C., optionally from 50° C. to 120° C., optionally from 80° C. to 90° C., and/or
at a humidity of 40% to 100%, optionally from 60% to 95%, optionally from 70% to 90%, and/or
over a duration of 10 min to 72 h,
optionally from 30 min to 50 h, optionally from 45 min to 10 h, optionally from 1 h to 3 h, optionally from 6 h to 60 h, optionally from 12 h to 55 h, optionally from 24 h to 52 h.

The graphite coating 26 on the respective webs 21 has been produced by a process in which at least one (polar) graphite suspension comprising graphite and at least one polar carrier liquid was first applied to the second surface region 28. This process may be selected from the group consisting of screen printing processes, roller printing processes, stencil printing processes, and combinations thereof. The polar carrier liquid can be a polar solvent, for example. Optionally, the polar carrier liquid has an Eₜ(30) value of at least 170 kJ/mol, optionally of at least 180 kJ/mol, optionally of at least 190 kJ/mol, optionally of at least 200 kJ/mol, optionally of at least 210 kJ/mol. The formation of the at least one graphite coating from the at least one graphite suspension applied was carried out, for example, by drying and/or at least one heat treatment.

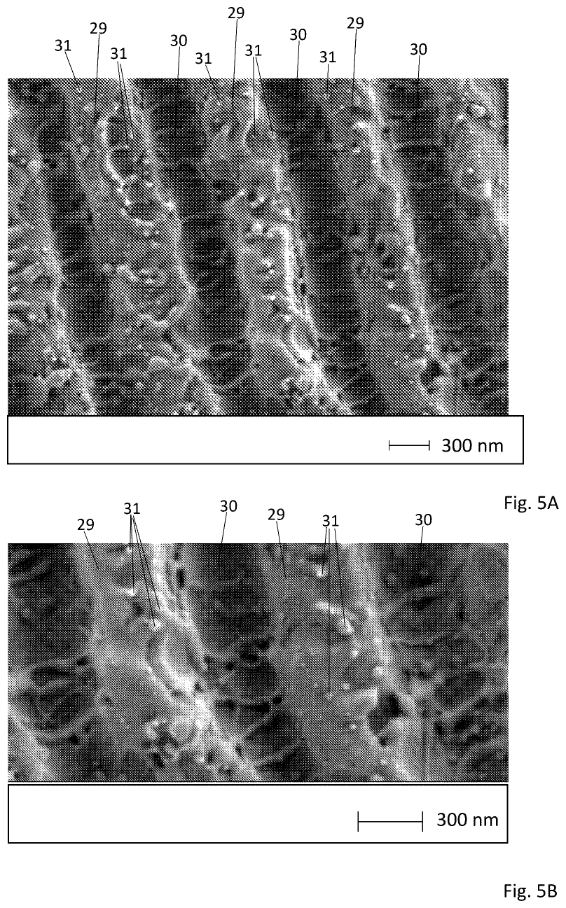

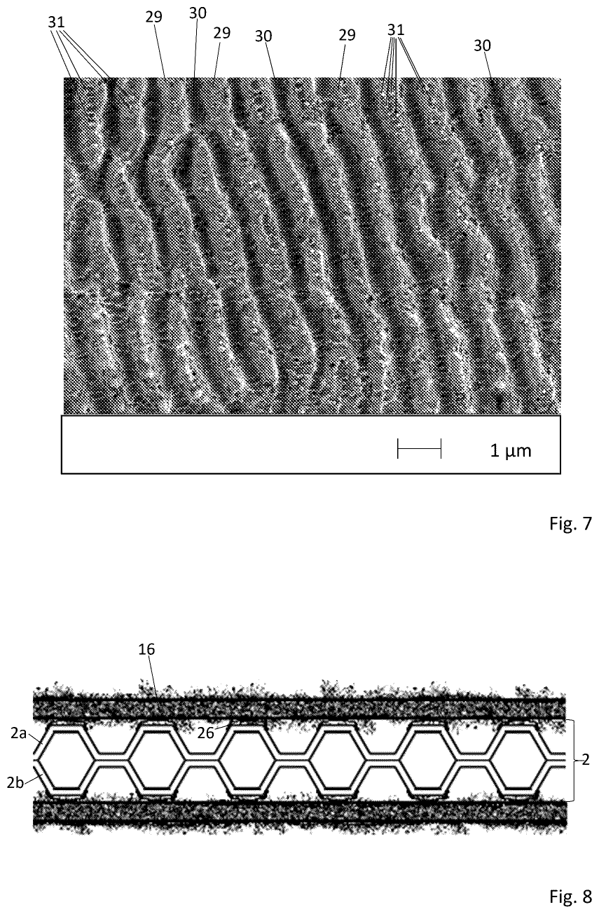

SEM images, as shown in FIG. 6A/B, can be used to characterize the surface structuring more precisely. FIG. 6A/B show an image of the surface structuring after the aging process. In addition, FIG. 5A/B shows an SEM image of the surface structuring before the aging process, while FIG. 5B shows an enlarged view of a section of the SEM image from FIG. 5A. FIG. 7 further shows another SEM image, which shows a larger section of the surface structuring. FIGS. 5A/B, 6A/B and 7 are each a section of the same sample, but not the same section.

The periodic structures are structures that are arranged periodically in relation to each other in at least one spatial direction. This means that the shape of the periodic structures on the surface is repeated in at least one spatial direction. The average spatial period of the periodic structures is less than 10 μm, optionally no more than 2 μm. The spatial period typically refers to the maximum distance between two neighboring structures of the same or similar shape, e.g. two of the substantially strip-shaped protrusions or two of the substantially strip-shaped depressions. Due to the manufacturing process, the structures are not completely identical to each other. The period is therefore subject to certain fluctuations along the surface. For example, the periodic structures can have a period in a spatial direction running parallel to the main extension plane of the surface (e.g. the spatial direction x running parallel to the x-axis 8) of less than 10 μm, optionally of at least 0.3 μm and/or at most 2 μm.

The periodic structures comprise alternately arranged substantially strip-shaped protrusions 29 and depressions 30, i.e. the periodic structures comprise substantially strip-shaped protrusions 29 and substantially strip-shaped depressions 30, wherein these protrusions 29 and depressions 30 are arranged alternately or alternately, i.e. the depressions 30 each extend between the (or in each case two of the) protrusions 29 and are bounded and/or formed by these. In addition, the substantially strip-shaped protrusions 29 and/or depressions 30 can be partially branched, as can be seen in FIG. 7.

The substantially strip-shaped protrusions 29 have a width in the range from 250 nm to 700 nm, optionally from 350 nm to 600 nm, and the substantially strip-shaped depressions 30 have a width in the range from 100 nm to 550 nm, optionally from 200 nm to 450 nm. The width is typically measured at half height and perpendicular to the local longitudinal direction of the depressions 30 or the protrusions 29. The length is typically measured along the longitudinal direction (or the course) of the depressions 30 or the protrusions 29.

Furthermore, the substantially strip-shaped depressions 30 have a depth in the range of 0.05 to 0.7 μm. The depth of the substantially strip-shaped depressions 30 can be determined using SEM (scanning electron microscopy), for example. The depth is usually measured perpendicular to the surface formed by the substantially strip-shaped protrusions. For example, the depth of the substantially strip-shaped depressions 30 can vary along the course of the individual depressions 30.

The nanostructures 31 are in the form of substantially point-shaped protrusions. Furthermore, the nanostructures 31 or the substantially point-shaped protrusions are arranged at least on the substantially strip-shaped protrusions 29. In addition, the nanostructures 31 can also be arranged in the form of substantially point-shaped protrusions on (or in) the substantially strip-shaped depressions 30. However, it is possible that the nanostructures 31 are arranged in the form of substantially point-shaped protrusions exclusively on the substantially strip-shaped protrusions 29. A respective circumferential edge of the substantially point-shaped protrusions can be substantially round (that is, circular), substantially elliptical or substantially oval.

Optionally, the nanostructures 31 are arranged in the form of the substantially point-shaped protrusions 29 on the edge regions of the substantially strip-shaped protrusions 29. Here, the edge region of the respective protrusion 29 represents the entire surface region of the respective protrusion 29 that lies above half the height of the protrusion 29, measured between the lowest and highest points of the protrusion 29 and represents the potential contact zone towards a gas diffusion layer.

The nanostructures 31 have (in each case) an average diameter in the range from 10 nm to 200 nm, optionally from 30 nm to 150 nm, optionally from 50 nm to 120 nm, and (in each case) a maximum diameter in the range from 10 nm to 300 nm, optionally from 30 nm to 250 nm, optionally from 50 nm to 200 nm. The diameter is typically measured here as a (linear) spatial distance running through the center of the respective nanostructure 31 between a first point of the outer edge of the respective nanostructure 31 and a second point of the outer edge of the nanostructure 31 opposite the first point. The average diameter can then be determined by averaging several measured diameter values (of a nanostructure). For example, the nanostructures 31 may (in each case) have a minimum diameter in the range from 5 to 60 nm, optionally from 1 0to 55 nm, optionally from 15 to 50 nm. Typically, the average diameter of the individual nanostructures 31 varies from nanostructure 31 to nanostructure 31 over a certain range, i.e. the nanostructures 31 vary in size.

Furthermore, the area size of the nanostructures 31 is in each case in the range from 80 nm² to 40,000 nm², optionally from 800 nm² to 20,000 nm², optionally from 2,000 nm² to 10,000 nm². The area size of a nanostructure 31 can be understood as the size of the area that the nanostructure 31 covers or occupies in the top view of the surface on which it is located. Typically, the area size of the individual nanostructures 31 varies from nanostructure 31 to nanostructure 31 over a certain range, i.e. the nanostructures 31 vary in size.

The surface structurings on at least the first two surface regions age as a result of the aging process. With this aging, the areal density of the nanostructures 31 increases in the form of point-shaped protrusions on the substantially strip-shaped protrusions 29. Accordingly, the areal density of the nanostructures 31 in the form of point-shaped protrusions on the substantially strip-shaped protrusions 29 in the aged surface structuring shown in FIG. 6A/B is greater than the areal density of the nanostructures 31 in the form of point-shaped protrusions on the substantially strip-shaped protrusions 29 in the non-aged surface structuring shown in FIG. 5A/B. The areal density of the nanostructures 31 on the substantially strip-shaped protrusions 29 is understood here to be the proportion of the total area of the substantially strip-shaped protrusions 29 that the nanostructures 31 in the form of point-shaped protrusions on the substantially strip-shaped protrusions 29 occupy or cover. Optionally, the total area of the substantially strip-shaped protrusions 29 is the sum of the areas of the edge regions of the substantially strip-shaped protrusions 29. Here, the edge region of the respective protrusion 29 represents the entire surface region of the respective protrusion 29 that lies above half the height of the protrusion 29, measured between the lowest point of an adjacent depression 30 and the highest point of the protrusion 29.

FIG. 8 schematically shows a cross-section through a section of a further electrochemical system 1 of the type of system 1 in FIG. 1 and FIG. 2, the sectional plane being aligned in the z-direction and thus perpendicular to the plate planes of the bipolar plates 2. In this exemplary embodiment of the bipolar plate 2 according to the present disclosure, the bipolar plate 2 comprises a (porous) gas diffusion layer 16, which is in contact with the graphite coating 26. This results in a defined interaction of the graphite coating 26 with the fibers of the gas diffusion layer 16. For example, it is possible for sections of the gas diffusion layer 16 to co-crosslink in/with the graphite coating 26.

In addition, the bipolar plates 2 of the electrochemical system of FIG. 8 can, for example, be designed like the bipolar plates 2 of the electrochemical system of FIG. 4A/B (that is, according to the relevant embodiments in this respect). In particular, this also applies to all information on surface structuring.

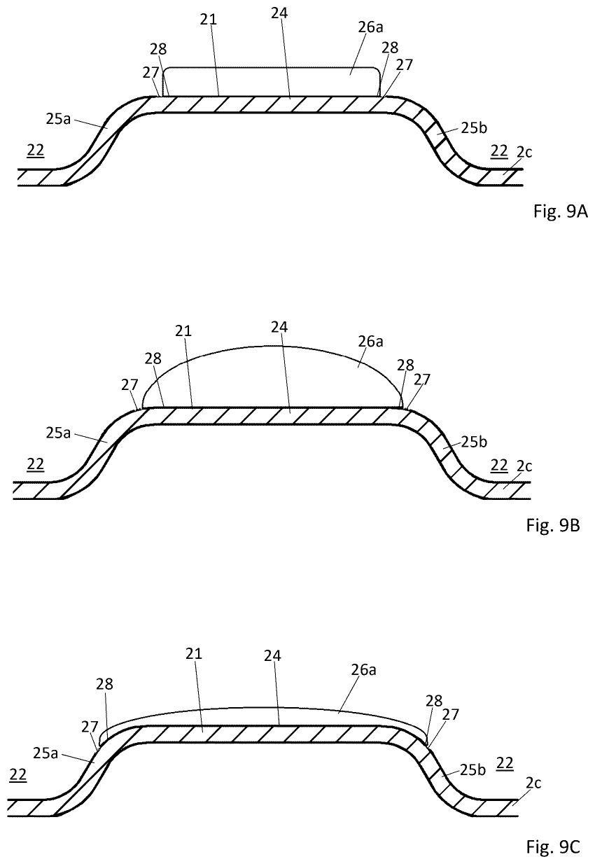

FIGS. 9A, FIG. 9B and FIG. 9C each schematically show a section of a portion of a metallic plate 2c during the implementation of an exemplary embodiment of the method according to the present disclosure for producing a bipolar plate which can be used as one of the separator plates 2a, 2b in an electrochemical system 1 of the type of the system 1 of FIG. 1 and FIG. 2. The metallic plate 2c is ultimately a separator plate that can be connected to another separator plate to form a bipolar plate. FIGS. 9A-C thereby relate to three different exemplary embodiments of the method according to the present disclosure, which lead to three different exemplary embodiments of the bipolar plate according to the present disclosure, wherein these differ from one another by the different position of the first and second surface regions 27 and 28.

In all three embodiments shown in FIGS. 9A-C, the metallic plate 2c comprises a plurality of webs 21 and channels 22 formed between the webs 21. In the sections shown in FIG. 9A-C, only one of the webs 21 between two channels 22 is shown as an example. The webs 21 each have a web crest 24 extending along the main direction of extension of the respective web as well as a first and a second web flank 25a and 25b each adjoining the web crest 24 and extending along the main direction of extension of the respective web.

In all three embodiments shown in FIGS. 9A-C, the webs 21 have two first surface regions 27 and a second surface region 28 arranged between the two first surface regions 27 and directly adjacent to the two first surface regions 27. Moreover, in all three embodiments shown in FIGS. 9A-C, the two first surface regions 27 and the second surface region 28 extend substantially parallel to a main direction of extension of the respective web 21 and optionally extend over the entire length of the respective web 21. In all three cases, the two first surface regions 27 can each have a width in the range from 90 μm to 460 μm, optionally from 95 μm to 300 μm, optionally from 100 μm to 200 μm.

FIGS. 9A-C each show a moment of the method in which the graphite suspension comprising graphite and at least one polar carrier liquid has just been applied to the second surface region 28, so that a wet layer 26a of the graphite suspension is disposed on the second surface region 28. A graphite coating can be formed from this, for example by drying and/or at least one heat treatment.

Accordingly, in all three embodiments shown in FIGS. 9A-C, the two first surface regions 27 each have a special surface structuring that is produced by laser treatment and a subsequent aging process. The surface structurings of the two first surface regions 27 have periodic structures and nanostructures 31, wherein the periodic structures comprise alternately arranged substantially strip-shaped protrusions 29 and depressions 30 and wherein the nanostructures 31 are formed in the form of substantially point-shaped protrusions and are arranged (at least) on the substantially strip-shaped protrusions 29.

In FIG. 9A, one of the two first surface regions 27 is disposed on an edge of the web crest 24 immediately adjacent to the first web flank 25a and the other of the two first surface regions 27 is disposed on an edge of the web crest 24 immediately adjacent to the second web flank 25b. The second surface region 28 extends almost (but not completely) across the entire width of the web crest 24, so that the web crest 24 is coated with the wet layer 26a almost (but not completely) across its entire width. Due to the surface structurings on the two first surface regions 27, the graphite suspension does not flow from the webs 21 into the channels 22, but stops at the two first surface regions 27. Accordingly, the graphite coating ultimately obtained is only arranged on the webs 21 and not in the channels 22. As a result, performance losses that would occur due to the lack of graphite coating on the web crests can be avoided.

In FIG. 9B, one of the two first surface regions 27 is arranged on an edge of the first web flank 25a directly adjacent to the web crest 24 and the other of the two first surface regions 27 is arranged on an edge of the second web flank 25b directly adjacent to the web crest 24. The second surface region 28 extends over the entire width of the web crest 24, so that the web crest 24 is coated with the wet layer 26a over its entire width. Due to the surface structurings on the two first surface regions 27, the graphite suspension does not flow from the webs 21 into the channels 22, but stops at the two first surface regions 27. Accordingly, the resulting graphite coating is only arranged on the webs 21 and not in the channels 22. As a result, performance losses that would occur due to the lack of graphite coating on the web crests can be avoided. In addition, compared to the embodiment shown in FIG. 9A, a larger area of the web crest 24 can be coated, so that the resulting graphite coating has a greater width. In this way, the performance of the bipolar plate or the electrochemical system can be increased.

In FIG. 9C, one of the two first surface regions 27 is disposed on the first web flank 25a, but not on an edge of the first web flank 25a immediately adjacent to the web crest 24, and the other of the two first surface regions 27 is disposed on the second web flank 25b, (but not on an edge of the second web flank 25b immediately adjacent to the web crest 24. The second surface region 28 extends over the entire width of the web crest 24 and also over a part of the first web flank 25a and the second web flank 25b, so that the web crest 24 is coated with the wet layer 26a over the entire width and also a part of the first web flank 25a and a part of the second web flank 25b are coated with the wet layer 26a. Due to the surface structurings on the two first surface regions 27, the graphite suspension does not flow from the webs 21 into the channels 22, but stops at the two first surface regions 27. Accordingly, the resulting graphite coating is only arranged on the webs 21-and not only on the web crest 24 but also on short sections of the web flanks 25a, 25b of the respective web 21-but not in the channels 22. As a result, performance losses that would occur due to the lack of graphite coating on the web crests can be avoided. In addition, compared to the embodiments shown in FIGS. 9A and 9B, a larger area of the web crest 24 can be coated, so that the resulting graphite coating has a greater width. In this way, the performance of the bipolar plate or the electrochemical system can be increased even further, as further contact points to the GDL 16 can be formed. This ensures the maximum possible performance over the entire flow field.

In addition to the features described here, the metallic plates 2c in FIGS. 9A-C can, for example, be designed like the separator plates 2a, 2b of the bipolar plate of the electrochemical system in FIGS. 4A/B (that is, in accordance with the relevant embodiments). In particular, this also applies to all information on surface structuring.

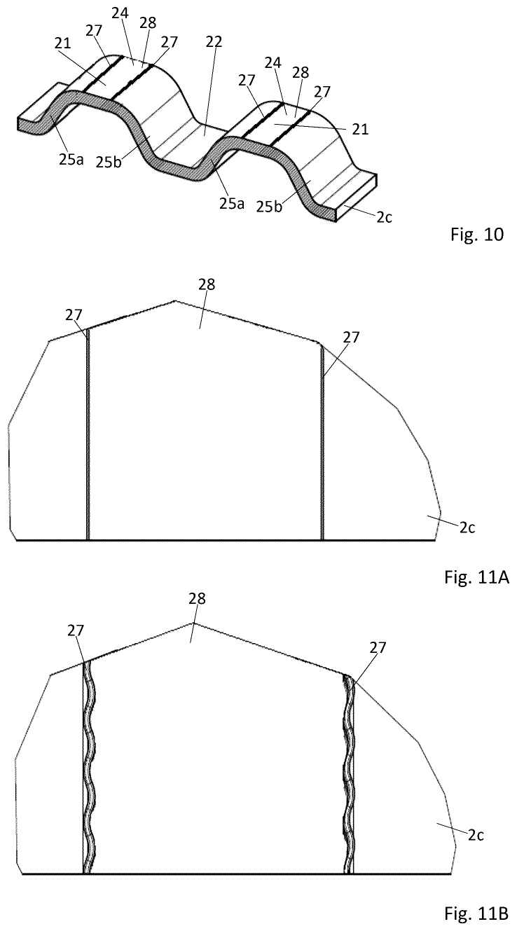

FIG. 10 schematically shows a section of a portion of a metallic plate 2c while carrying out an exemplary embodiment of the method according to the present disclosure for producing a bipolar plate which can be used in an electrochemical system 1 of the type of system 1 of FIG. 1 and FIG. 2. The metallic plate 2c is ultimately a separator plate that can be connected to another separator plate to form a bipolar plate or that can be used as a one-layered bipolar plate.

In the exemplary embodiment of the method according to the present disclosure shown in FIG. 10, the metallic plate 2c comprises a plurality of webs 21 and channels 22 formed between the webs 21. In the section shown in FIG. 10, only two of the webs 21 are shown by way of example, between which a channel 22 is arranged. The webs 21 each have a web crest 24 extending along the main direction of extension of the respective web as well as a first and a second web flank 25a and 25b each adjoining the web crest 24 and extending along the main direction of extension of the respective web.

The webs 21 each have two first surface regions 27 and a second surface region 28 arranged between the two first surface regions 27 and directly adjacent to the two first surface regions 27. In addition, the two first surface regions 27 and the second surface region 28 extend substantially parallel to a main direction of extension of the respective web 21 and may extend over the entire length of the respective web 21. The two first surface regions 27 can each have a width in the range from 90 μm to 460 μm, optionally from 95 μm to 300 μm, optionally from 100 μm to 200 μm.

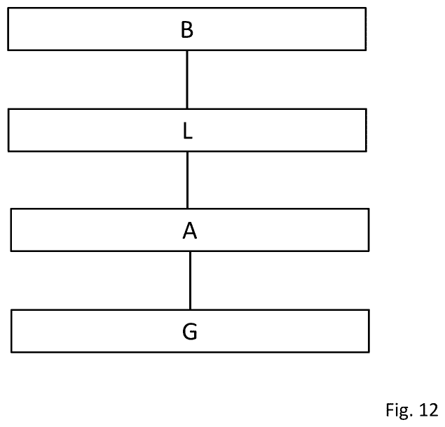

Shown in FIG. 10 is a moment during the method that occurs after the aging process of the two first surface regions 27 of the webs 21 but before coating of the respective second surface region 28 of the webs 21 with at least one graphite coating, i.e. after the process step A and before the process step G of FIG. 12.

Accordingly, in the variant shown in FIG. 10, the two first surface regions 27 of the webs 21 each have a special surface structuring, which is produced by laser treatment and a subsequent aging process. The surface structurings of the two first surface regions 27 have periodic structures and nanostructures 31, wherein the periodic structures comprise alternately arranged substantially strip-shaped protrusions 29 and depressions 30 and wherein the nanostructures 31 are formed in the form of substantially point-shaped protrusions and are arranged at least on the substantially strip-shaped protrusions 29.

If, in the next process step, the respective second surface region 28 of the webs 21 is coated with at least one graphite coating, whereby at least one graphite suspension comprising graphite and at least one polar carrier liquid is applied to the second surface region, the graphite suspension does not flow from the webs 21 into the channels 22, but stops at the two first surface regions 27. Accordingly, the resulting graphite coating is only arranged on the webs 21 and not in the channels 22. As a result, performance losses that would occur due to the lack of graphite coating on the web crests can be avoided.

In addition to the features described here, the metallic plate 2c of FIG. 10 can, for example, be designed like the separator plates 2a, 2b of the bipolar plate of the electrochemical system of FIG. 4A/B (that is, according to the relevant embodiments). In particular, this also applies to all information on surface structuring.

FIG. 11A and FIG. 11B each show a schematic top view of a section of a metallic plate 2c, as shown in FIG. 10. The statements made there therefore also apply here. In the exemplary embodiment in FIG. 11A, the two first surface regions 27 each have a linear course. In the exemplary embodiment in FIG. 11B, the two first surface regions 27 have a corrugated course.

Finally, FIG. 12 summarizes the method for manufacturing the bipolar plate according to the present disclosure. First, in step B, at least one metallic plate is provided, which comprises a plurality of webs and channels formed between the webs. This can be done, for example, by forming webs and channels into a plate, such as a stainless-steel plate of alloy 1.4404 with a sheet thickness of 0.075 mm. In step L, each of at least two first surface regions of the webs are subjected to at least one laser treatment, in which the at least two first surface regions are irradiated with laser pulses by means of a pulsed laser. The first surface regions of the webs can, for example, be subjected to laser treatment with a laser with a wavelength of 1064 nm and a pulse duration of <15 ps at a frequency of 50 kHz and a total fluence of 80 J/cm² or a fluence per pulse of 0.577 J/cm². This produces periodic structures which, on the one hand, comprise alternately arranged, substantially strip-shaped protrusions and depressions and, on the other hand, have nanostructures in the form of substantially point-shaped protrusions which are arranged in particular on the substantially strip-shaped protrusions. In step A, the at least two first surface regions are then subjected to an aging process. To achieve the desired surface properties, the plate can, for example, be subjected to an aging process by being exposed to 90° C. and 80% humidity for 2 hours. After completion of the aging process, at least one second surface region of the webs, which is arranged between the at least two first surface regions and is directly adjacent to the at least two first surface regions, is coated with at least one graphite coating in process step G, as is known, for example, from the prior art.

### LIST OF REFERENCE SIGNS

1 electrochemical system
2 bipolar plate
2a separator plate
2b separator plate
2c metallic plate
3 end plate
4 end plate
5 media port
7 z-direction
8 x-direction
9 y-direction
10 membrane electrode assembly (MEA)
11a through-opening
11b through-opening
11c through-opening
12a sealing bead
12b sealing bead
12c sealing bead
12d sealing bead
13a passage
13b passage
13c passage
14 membrane
15 edge reinforcement of the membrane
16 gas diffusion layer
17 flow field
18 active region
19 cavity
20 distribution or collection region
21 web
22 channel
23 contact region
24 web crest
25a first web flank
25b second web flank
26 graphite coating
26a wet layer
27 first surface region
28 second surface region
29 substantially strip-shaped protrusion
30 substantially strip-shaped depression
31 nanostructure

1. A method of manufacturing a bipolar plate for an electrochemical system, in which
a) at least one metallic plate is provided, which comprises a plurality of webs and channels formed between the webs,
b) each of at least two first surface regions of the webs are subjected to at least one laser treatment, in which the at least two first surface regions are irradiated by means of a pulsed laser with laser pulses which have a pulse duration of less than 1 ns, wherein the at least one laser treatment produces surface structurings on the at least two first surface regions, wherein the surface structurings comprise periodic structures comprising alternately arranged substantially strip-shaped protrusions and substantially strip-shaped depressions, as well as nanostructures in the form of substantially point-shaped protrusions that are arranged at least on the substantially strip-shaped protrusions,
c) the at least two first surface regions are, after step b), subjected to an aging process, whereby the surface structurings on the at least two first surface regions age and thereby an areal density of the nanostructures on the substantially strip-shaped protrusions increases, and
d) at least one second surface region of each of the webs that is arranged between the at least two first surface regions and is directly adjoining the at least two first surface regions, is coated with at least one graphite coating, wherein at least one graphite suspension comprising graphite and at least one polar carrier liquid is applied to the at least one second surface region.

2. The method according to claim 1, wherein
the pulse duration of the laser pulses is less than 100 ps, and/or
a fluence introduced into the at least two first surface regions by irradiation with the laser pulses is in a range from 15 J/cm² to 120 J/cm².

3. The method according to claim 1, wherein the aging process takes place
at a temperature in the range from 10° C. to 150° C., and/or
at a humidity of 40% to 100%, and/or
over a period of 10 min to 72 h.

4. The method according to claim 1, wherein
the substantially strip-shaped protrusions have a width in the range from 250 nm to 700 nm, and/or the substantially strip-shaped depressions have a width in the range from 100 nm to 550 nm, and/or
the nanostructures have an average diameter in the range from 10 nm to 200 nm, and/or
the nanostructures have a maximum diameter in the range from 10 nm to 300 nm, and/or
the nanostructures each have a surface area in the range from 80 nm² to 40,000 nm².

5. The method according to claim 1, wherein the areal density of the nanostructures on the substantially strip-shaped protrusions
before the aging process is in the range from 0.3 to 5%, and/or
after the aging process is in the range of 1 to 10%.

6. The method according to claim 1, wherein the at least one metallic plate is formed from stainless steel and/or at least one titanium alloy.

7. The method according to claim 1, wherein coating of the at least one second surface region with the at least one graphite coating is performed by a method selected from the group consisting of screen printing methods, roller printing methods, stencil printing methods, and combinations thereof.

8. The method according to claim 1, wherein
the at least two first surface regions and/or the at least one second surface region extend substantially parallel to a main direction of extension of the respective web and/or extend over the entire length of the respective web, and/or
the at least two first surface regions each have a width in the range from 90 μm to 460 μm.

9. The method according to claim 1, wherein the webs each have a web crest and a first web flank and a second web flank, each of which adjoins the web crest, wherein
at least one of the at least two first surface regions is arranged on the first web flank, and/or on the web crest, and at least one further first surface region of the at least two first surface regions is arranged on the second web flank, and/or on the web crest, and/or
the at least one second surface region is arranged on the web crest, wherein the at least one second surface region extends over the entire width of the web crest.

10. A bipolar plate for an electrochemical system, comprising at least one metallic plate having a plurality of webs and channels formed between the webs, wherein each of the webs has at least two first surface regions and at least one second surface region disposed between the at least two first surface regions and immediately adjoining the at least two first surface regions, wherein the at least two first surface regions have surface structurings, which comprise periodic structures comprising alternately arranged substantially strip-shaped protrusions and depressions, and nanostructures in the form of substantially point-shaped protrusions which are arranged at least on the substantially strip-shaped protrusions, and wherein the at least one second surface region is at least one surface region coated with at least one graphite coating.

11. The bipolar plate according to claim 10, wherein
the substantially strip-shaped protrusions have a width in the range from 250 nm to 700 nm, and/or the substantially strip-shaped depressions have a width in the range from 100 nm to 550 nm, and/or
the nanostructures have an average diameter in the range from 10 nm to 200 nm, and/or
the nanostructures have a maximum diameter in the range from 10 nm to 300 nm, and/or
the nanostructures each have a surface area in the range from 80 nm² to 40,000 nm²,, and/or
the areal density of the nanostructures on the substantially strip-shaped protrusions (29) is in the range from 1 to 10%.

12. The bipolar plate according to claim 10, wherein the at least one metallic plate is formed from stainless steel and/or at least one titanium alloy.

13. The bipolar plate according to claim 10, wherein
the at least two first surface regions and/or the at least one second surface region extend substantially parallel to a main direction of extension of the respective web and/or extend over the entire length of the respective web, and/or
the at least two first surface regions each have a width in the range from 90 μm to 460 μm.

14. The bipolar plate according to claim 10, wherein the webs each have a web crest and a first and a second web flank, each of which adjoins the web crest, wherein
at least one of the at least two first surface regions is arranged on the first web flank, and/or on the web crest, and at least one further first surface region of the at least two first surface regions is arranged on the second web flank, and/or on the web crest, and/or
the at least one second surface region is arranged on the web crest, wherein the at least one second surface region extends over the entire width of the web crest.

15. The bipolar plate according to claim 10, wherein the at least one graphite coating has an average thickness of at least 5 μm.

16. The bipolar plate produced by the method according to claim 1.

17. An electrochemical system comprising at least one bipolar plate according to claim 10, wherein the electrochemical system is an electrochemical cell or a stack comprising a plurality of electrochemical cells.
